(19) United States
(12) Patent Application Publication
(10) Pub. No.: US 2003/0058994 A1
(43) Pub. Date: Mar. 27, 2003

(54) Computed tomography method and apparatus for registering data with reduced radiation stress to the patient

(76) Inventor: Otto Sembritzki, Wachenroth (DE)

Correspondence Address: SCHIFF HARDIN & WAITE, 6600 SEARS TOWER, 233 S WACKER DR, CHICAGO, IL, 60606-6473, US

(21) Appl. No.: 10/226,658

(22) Filed: Aug. 23, 2002

(30) Foreign Application Priority Data
Aug. 23, 2001 (DE) 10141346.7

(51) Int. Cl. H05G 1/44

(52) U.S. Cl. 378/108

(57) ABSTRACT

In computed tomography a method and apparatus for registering measured data of a small region of interest, an X-ray source is rotated around an examination axis while emitting an X-ray beam that widens in a slice plane perpendicular to the examination axis. The intensity distribution of the X-rays within the X-ray beam during the measured data registration is varied and controlled dependent on the region of interest such that regions of the slice plane outside the region of interest are charged with a lower X-ray dose than the region of interest. The dose stress on the patient is substantially reduced when only small regions of the available measurement field are utilized for diagnosis. The dose reduction is independent of whether the region of interest lie in or outside the rotational center of the computed tomography apparatus.

### BACKGROUND OF THE INVENTION

1. Field of the Invention

The present invention is directed to a method for registering measured data of a small region of interest employing a computed tomography apparatus of the type having an X-ray source rotatable around an examination axis for the emission of an X-ray beam that widens in a slice plane perpendicular to the examination axis. The invention also is directed to a computed tomography apparatus with a device for the implementation of the inventive method.

2. Description of the Prior Art

Among other things, a computed tomography apparatus has an X-ray tube, X-ray detectors and a patient table. The X-ray tube and the X-ray detectors are arranged at a gantry that rotates around the patient table during the measurement, i.e., around an examination axis proceeding parallel to the table. The patient table can be moved along the examination axis relative to the gantry. The X-ray tube generates an X-ray beam that widens in a fan-shape in a slice plane perpendicular to the examination axis. In examinations in the slice plane, this X-ray beam penetrates a slice of a subject, for example a body slice of a patient on the patient table, and strikes the X-ray detectors lying opposite the X-ray tube. The angle at which the X-ray beam penetrates the body slice of the patient continuously changes relative to the gantry during the image exposure with the computed tomography apparatus, as may the position of the patient table.

The intensity of the X-rays of the X-ray beam that strikes the X-ray detectors after penetrating the patient is dependent on the attenuation of the X-rays by the patient. Dependent on the intensity of the received X-rays, each X-ray detector generates a voltage signal that corresponds to a measurement of the overall transparency of the body for X-rays in a path from the X-ray tube to that X-ray detector. A set of voltage signals from the X-ray detectors that represent attenuation data, and that were registered for a specific position of the X-ray source relative to the patient, is referred to as a projection. A set of projections that were registered at different positions of the gantry during the revolution of the gantry around the patient is referred to as a scan. For each projection, a detector referred to as a monitor detector among the X-ray detectors measures the intensity of unattenuated X-rays of the X-ray beam, and this is used for normalization of the voltage values of the voltage signals of the X-ray detectors and for determining the overall attenuation of the intensity of the X-radiation. The computed tomography apparatus registers many projections at different positions of the X-ray source relative to the body of the patient in order to reconstruct an image that corresponds to a two-dimensional tomogram of the body of the patient or to a three-dimensional image. The standard procedure for reconstructing a tomogram from registered attenuation data is known as the method of filtered back-projection.

The quality of a reconstructed tomogram of a body slice of a patient is primarily dependent on the quantum noise of the X-ray detectors, which is related to the X-ray dose that was employed for the acquisition of the attenuation data and to the beam attenuation characteristic of the patient. The measurement field of the computed tomography apparatus over which the registration of measured data ensues is primarily determined by the widening of the X-ray beam and by the distance of the X-ray source or, X-ray detectors from the examination axis. In many examinations, however, the only item of interest is a smaller region of the respective body slice of the patient within the measurement field. For calculating CT images of this region of interest (ROI), the measured data from the entire measurement field of the computed tomography apparatus are utilized with different weightings. The X-ray dose applied in the measurement, however, must be selected high enough so that the reconstructed image of the region of interest still exhibits an adequate image quality, i.e. lies clearly above the noise.

An increase in the X-ray dose, however, leads to a greater stress on the patient. There is thus a need for a method for the operation of an computed tomography wherein the patient is subjected to a lower X-ray stress.

Various methods have been disclosed for reducing the X-ray stress on the patient in the measured data registration with a computed tomography apparatus. Thus, German OS 198 07 639 discloses a method wherein the X-ray dose required for an adequate image quality is separately determined in advance for every individual projection, and the power of the X-ray tube is correspondingly modulated during a scan. This method, known by the name of dose modulation, takes into consideration that the X-ray dose for each projection required for producing a qualitatively high-grade X-ray image is dependent on the maximum attenuation value within this projection. Only that X-ray dose that is required for detector signals above the quantum noise of the entire measurement field is thus employed per projection.

In another technique such as utilized, for example, in commercially available computed tomography systems of Siemens AG, a filter or a diaphragm with a centrally located maximum beam passage (pass maximum) limits the widening of the X-ray beam during exposures wherein the region of interest lies in the rotational center of the computed tomography apparatus. In this way, uninteresting edge regions of the measurement field of the computed tomography apparatus are charged with a lower X-ray dose. This overall dose reduction technique leads to a dose reduction by a factor of 2 through 5 in the edge regions but can be only employed in those instances wherein the region of interest lies in the rotational center of the computed tomography apparatus.

### SUMMARY OF THE INVENTION

An object of the present invention is to provide a method for measured data registration of small regions of interest with a computed tomography apparatus that enables a clear dose reduction with high image quality of the region of interest, as well as to provide a computed tomography apparatus for the implementation of the method.

The above object is achieved in accordance with the principles of the present invention in a computed tomography method and apparatus for registering measured data of a small region of interest, wherein an X-ray source is rotated around an examination axis while emitting an X-ray beam that widens in a slice plane perpendicular to the examination axis, and wherein the intensity distribution of X-rays within the X-ray beam during the data registration is varied and controlled dependent on the region of interest such that regions of the slice plane outside of the region of interest are charged with a lower X-ray dose than the region of interest.

The important feature of the present method is to modify the intensity distribution of the X-radiation within the X-ray beam during the measured data registration and to control it dependent on the region of interest such that regions of the slice plane outside the region of interest are charged with a lower X-ray dose than the region of interest. The dose distribution over the measurement channels or detectors of every projection thus is controlled dependent on the position and size of the region of interest.

A dose distribution adapted to the region of interest is achieved with this method, so that the patient dose outside this region of interest is reduced. Compared thereto, all regions of the measurement are charged with the same dose in every projection in the conventional methods for dose modulation. In contrast to the technique of overall attenuation of regions lying far outside the rotational center of the computed tomography apparatus, the present method can be applied given regions of interest that is arbitrarily located within the measurement field. Since only the slice regions that are not relevant for the image calculation of the region of interest are charged with a lower dose in the inventive method, a high-quality two-dimensional tomogram is nonetheless achieved.

The variation and control of the intensity distribution within the X-ray beam preferably ensues with a filter introduced into the beam path of the X-ray beam that exhibits a filter characteristic comprising a central pass maximum. Dependent on the position of the region of interest within a projection, this filter is shifted transversely to the X-ray beam in the slice plane from projection to projection. The filter thus is respectively re-adjusted during a scan, so that the region of interest lies within the pass maximum of the filter in each projection. In the preferred embodiment, the width of the pass maximum of the filter is simultaneously mechanically adjusted corresponding to the size of the region of interest within each projection. It is the regions of interest lying outside the rotational center for which this size of the region of interest varies, geometrically dependent, from projection to projection. Such variation also can result from a non-rotationally symmetrical shape of the region of interest. The mechanically movable filter is preferably attached in the X-ray diaphragm mechanism of the computed tomography apparatus. The region of interest prescribed by the user of the computed tomography apparatus determines the location to which the filter movable in fan direction of the fan-shaped X-ray beam is displaced, and in which scan angles or projections.

Additionally, it is necessary to take the channel-dependent dose distribution as a result of the filter insert into consideration in the calibration of the measured data. This can ensue by producing stored calibration tables that are produced dependent on the size and position of the region of interest and that contain the location-dependency of the dose distribution for respective regions of interest. For producing such calibration tables, a few frequently occurring regions of interest can be prescribed and corresponding angle-dependent and channel-dependent air calibration tables can be stored.

In a preferred embodiment of the present method, however, the correction of the logarithmized measured values in the software-assisted pre-processing ensues by means of local subtraction of the additional attenuation due to the filter. Since the filter preferably generates a nearly constant attenuation outside the region of interest or the pass maximum of the filter, this attenuation commencing discontinuously in the direction of the measurement channels or detector line, a simple detection of the transition to the attenuated region and a correction of the measured values of the attenuated region is possible by subtracting calibration values. Given a dose reduction by 90%, i.e. an attenuation of the filter of, for example, e^{-μd}=10 in the logarithmized measured values, a local boost by Cg*log(10)=5282 GU, with Cg=512/ln(1.25)≈2294 thus arises as a scaling factor that is standard in computed tomography.

Preferably, the attenuation factor of the filter outside the pass maximum is selected such that the measured signal still lies clearly above the electronics noise. The X-ray dose required for this purpose can be determined by means of a rough estimate, or by means of a pre-scan over a small part of the body region of the patient to be examined. The region of interest also can be exactly defined on the basis of such a pre-scan, the position and size of this region of interest having to be known before the implementation of the method.

The measured data lying outside the region of interest that are acquired in a scan preferably are noise-reduced by means of a smoothing or filtering. The regions outside the region of interest can be reconstructed from the measured data and displayed. Even though these image regions are much noisier than the region of interest, they nonetheless can be useful for certain applications.

The inventive computed tomography apparatus has a known arrangement of an X-ray source at a gantry that is rotatable around an examination axis for the emission of an X-ray beam that widens in a slice plane perpendicular to the examination axis, a number of detectors for acquiring the incident X-rays as well as a controller for the measured data registration. In accordance with the invention a filter having a central pass maximum is seated mechanically displaceable in the slice plane transversely relative to the X-ray beam. The filter has a drive for the displacement transversely relative to the X-ray beam and preferably has a further drive for adjusting the width of the pass maximum. Both drives are connected to the controller, which has a unit for operating the drives of the filter for the implementation of the above-described method. The computed tomography apparatus has comprises an evaluation unit for reconstructing a tomogram from the acquired measured data. This evaluation unit preferably includes a unit for calibrating the measured data to the attenuation values of the filter.

The filter is preferably formed as a diaphragm-like arrangement having a central opening forming to the pass maximum. The material and the material thickness outside the opening are suitably selected to achieve the desired attenuation of the X-rays. Those skilled in the art are familiar with suitable materials for attenuating X-rays.

### DESCRIPTION OF THE DRAWINGS

FIG. 1 is a schematic illustration of a portion of a computed tomography apparatus for acquiring tomograms of a body slice of a patient.

FIG. 2 is a schematic illustration and block diagram of components of a computed tomography apparatus for implementation of the inventive method.

FIG. 3 is a simplified illustration of the geometrical relationships in the implementation of the inventive method;

FIG. 4 is an attenuation value profile of a water phantom.

FIG. 5 is an example of the attenuation value curve of the filter of the present method over the channels at one tube position.

FIG. 6 is the attenuation value profile of a water phantom measured with utilization of a filter according to FIG. 5.

### DESCRIPTION OF THE PREFERRED EMBODIMENTS

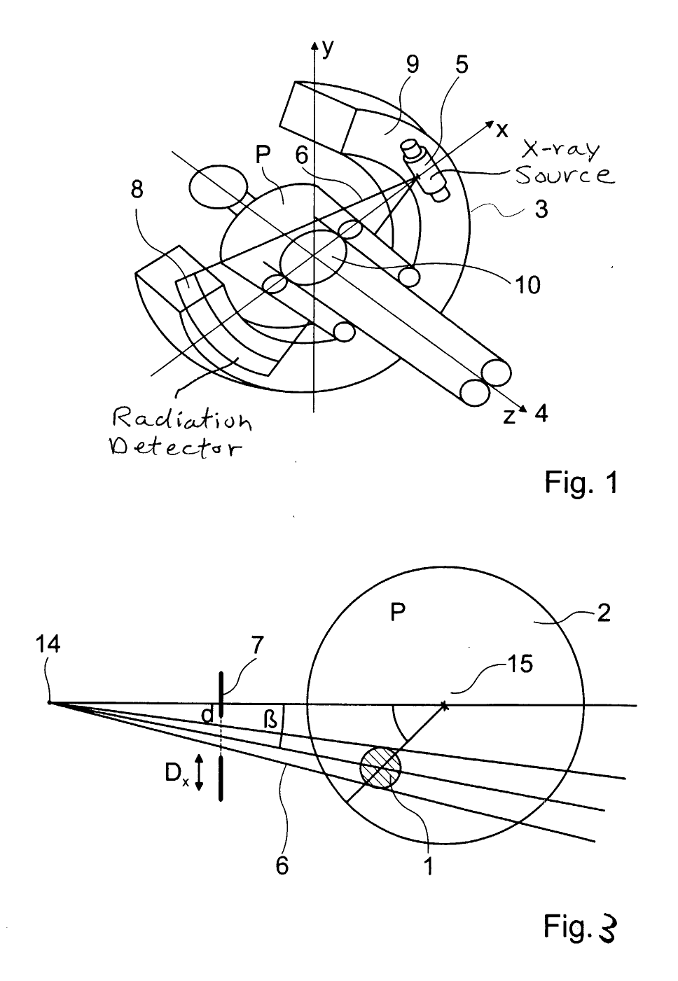

FIG. 1 of a part of a computed tomography apparatus 3 for showing the geometrical relationships in the measured data registration. The computed tomography apparatus 3 has an X-ray source in the form of an X-ray tube 5 that emits a fan-shaped X-ray beam 6 in a direction proceeding to a detector bank 8 of, for example, 768 X-ray detectors. The X-ray tube 5 as well as the detector bank 8 are arranged at a gantry 9 that can continuously rotate around a patient P. The patient lies on a patient table (not shown in FIG. 1) that extends into the gantry 9. The gantry 9 rotates in the x-y plane of a Cartesian coordinate system x-y-z indicated in FIG. 1. The patient table is movable along the z-axis, which corresponds to the examination axis of the computed tomography apparatus 3. FIG. 1 also shows the slice 10 transirradiated by the X-ray beam 6 for which a tomogram is to be produced.

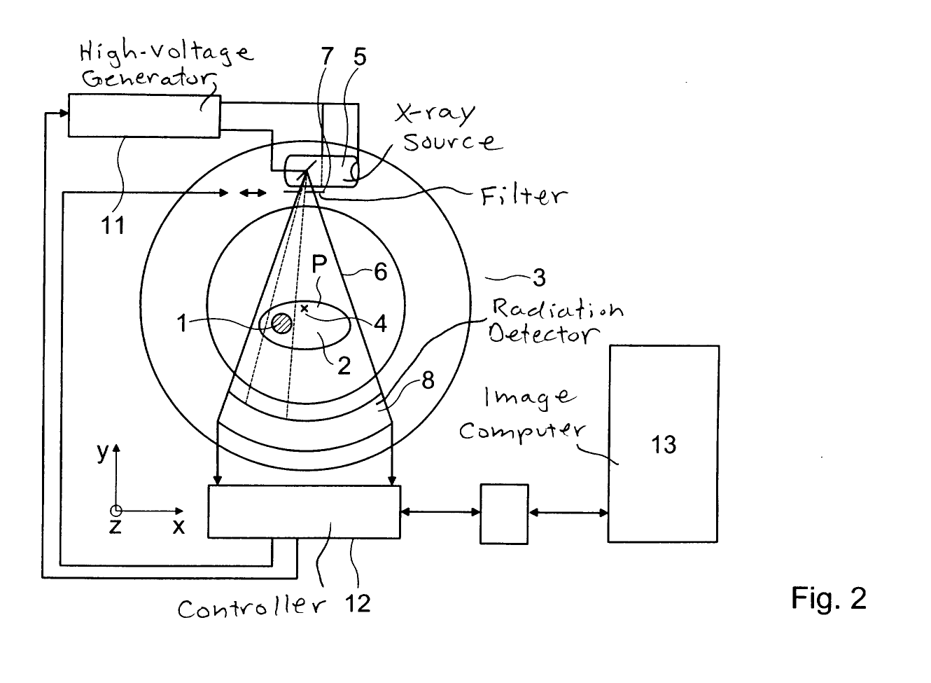

FIG. 2 is a schematic illustration and block diagram that shows the basic system components of the inventive apparatus, which can be used in the computed tomography apparatus 3 of FIG. 1. The gantry 9 with the X-ray tube 5 and the detector bank 8 lying there opposite can be seen in FIG. 2. The X-ray tube 9 is supplied with a high-voltage of, for example, 120 kV from a high-voltage generator 11. A controller 12 serves for the drive of the individual components of the inventive computed tomography apparatus 3, particularly the high-voltage generator 11, the gantry 9, the detectors of the detector bank 8 as well as of the patient bed (not shown) for the implementation of the measured data registration. The measured data are forwarded to an image computer 13 in which the image reconstruction based on the measured data ensues.

The X-ray beam 6, that widens in a fan-shape in the slice plane, also can be seen in FIG. 2. The beam 6 strikes the detector bank 8 after being attenuated by the patient body P.

A region of interest 1 (ROI) is indicated in the present example within the illustrated slice of the patient P, this being covered by the fan-shaped ray beam 6. Only this smaller region 1 within the measurement field of the computed tomography apparatus is to be of significance for the examination given the present example, so that only the image region that shows the ROI 1 need be present with good image quality.

For reducing the patient dose, a mechanically movable filter 7 is secured to the X-ray diaphragm mechanism of the gantry 9 in the exemplary embodiment, the filter 7 having a central pass maximum for X-rays. Further, the width of the pass maximum of this filter 7 can be mechanically adjusted. The displacement of the filter 7 as well as the adjustment of the width of the pass maximum are undertaken by the controller 12 dependent on the position and size of the ROI 1. The control ensues such that regions 2 of the measurement field outside the region of interest 1 are charged with a lower X-ray dose than the region of interest 1. The region of higher intensity within the X-ray beam 6 as a result of this filter 7 is indicated by the broken lines in the snapshot of FIG. 2. Given variation of the projection angle, the controller 12 correspondingly varies the position as well as the aperture width of the filter 7.

During operation of the computed tomography apparatus, the fan-shaped X-ray beam 6 penetrates a body slice of the patient P and strikes the detector bank 8. The X-ray detectors of the detector bank 8 generate voltage signals at the 768 different detector channels as a consequence of the incident X-rays, the signals from the respective detector channels being supplied to the image computer 13 by the controller 12. In this way, up to 1000 projections or more are measured per revolution of the gantry around the examination axis 4 in order to obtain a tomogram of this body slice of the patient P after implementation of a filtered back-projection in the mage computer 13. The reconstructed tomograms are usually displayed on a monitor (not shown) that is connected to the image computer 13.

In the present example, either the region of interest 1 by itself or the entire measurement region of the measurement field, can be reconstructed. In either case, the region of interest 1 exhibits a high image quality, whereas the uninteresting regions 2 appear highly noise-infested (if they are included in the reconstruction). As a result of the filtering adapted to the region of interest 1, however, the patient dose is significantly reduced overall without losing essential image information needed for the examination.

The present method is explained again with reference to FIG. 3 that shows the geometrical relationships in the implementation of a computed-tomographic exposure. The present method proceeds from the recognition that not all of the information of the measurement field of a computer tomograph is not needed for the calculation of the image of a region of interest 1. To that end, the region 2 outside the region of interest 1 is highly attenuated by the additional filter 7 and the patient dose thus is considerably reduced. This filter 7 is adapted to the region of interest 1 in terms of its position and width. The focus 14 of the X-ray beam 6 in the X-ray source, the examination subject P as well as the region of interest 1 within the subject P can be seen in cross-section in FIG. 3. FIG. 3 shows only an excerpt of the X-ray beam 6, that usually extends beyond the subject P. The additional filter 7 introduced into the X-ray beam 6 is displaceable in the direction illustrated by the arrow and also can be adjusted in this direction as to its aperture width, i.e. the width of its pass maximum.

The center of the region of interest 1 viewed proceeding from the focus 14 in the illustrated projection appears at the angle β=β(α) relative to the rotational center 15 of the computed tomography apparatus and α indicates the momentary angular position of the X-ray tube 5 or the focus 14, in the rotation around the examination axis 4. The position of the filter 7, accordingly, must be re-adjusted by the path

Dx=d_{coll}*tan(β)

proceeding from a central position on the connecting line between the focus 14 and the rotational center 15, with d_{coll} being the distance of the filter 7 from the focus 14 of the X-ray beam 6. The aperture of the filter 7 must at least assume the value

d=d0*d_{coll}/d_{ROI}

wherein d0 is the diameter of the region of interest 1 in the respective projection and d_{ROI} is the distance of the region of interest 1 from the focus 14. It is clear that, given a revolution of the focus 14 around the center 15, the displacement Dₓ as well as the aperture width d of the filter change dependent on the rotational angle α. This change ensues continuously during the measured data registration. In this way, the dose is significantly reduced in the regions 2 outside the region of interest 1.

The reduction, however, should not be selected as too excessive. A value can be prescribed as an upper limit at which the number of X-ray quanta striking each detector generates a signal that lies clearly above the electronics noise.

Given, for example, a lumbar column (LWS) mode (260 mAs; 130 mA; 1.5 mm; FoV=150 mm), a reduction of the number of quanta occurs by the factor Aqlws=240/130*10/1.5 =12. A value A_lws of approximately e^{30 cm*0.2/cm}=400 can be estimated as the subject attenuation. This yields an overall attenuation value of about 4800, so that an additional attenuation by the factor of 8 by the additional filter 7 should not be exceeded given a limit attenuation of the computed tomography apparatus of approximately 38000—in the case of highest power of 31 kW given 130 kV and 240 mA.

When subjects having lower attenuation are examined, then the dose reduction can be set correspondingly higher. Given other types of computed tomography systems, corresponding device-specific considerations can be made for estimating the maximum attenuation by the filter 7 that can be tolerated.

For the example of an inner ear examination (1 mm; 90 mA; FoV=150 mm), the number of quanta is reduced by the factor A_qinn=240/90*10/1=27. A value A_inn of approximately e^{10 cm*0.4/cm+10 cm*0.2/cm} can be assumed as the subject attenuation in the inner ear, so that an attenuation value of 3 could remain for the utilization of the additional filter 7.

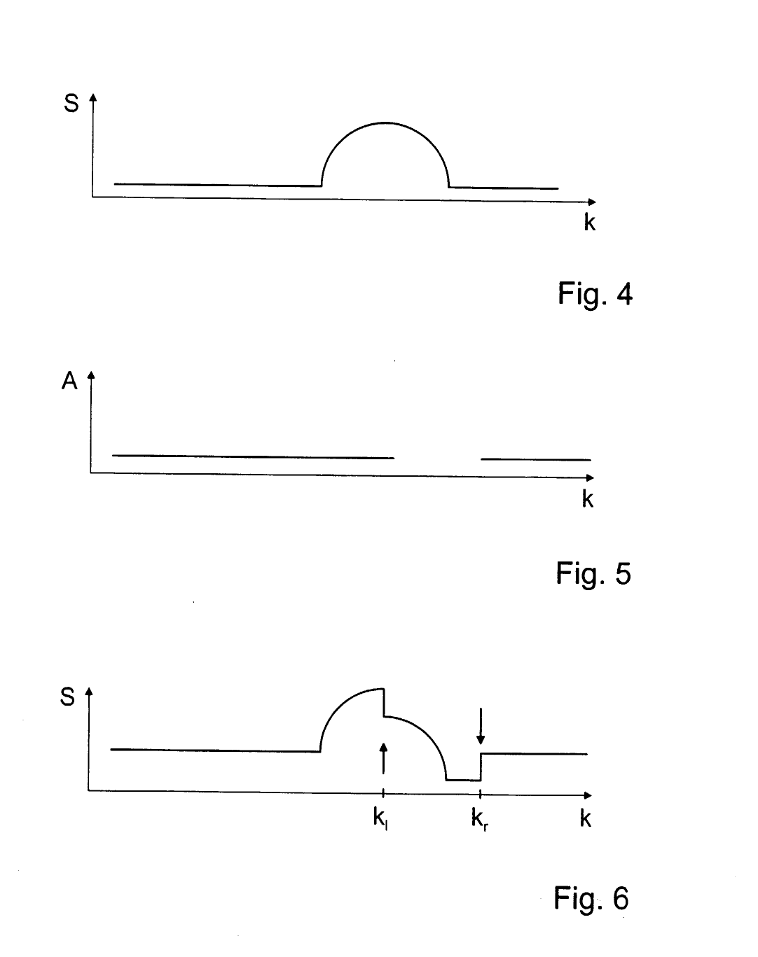

FIG. 4 schematically shows the attenuation profile S of a water phantom of a projection over the measurement channels k, as obtained with a computer tomograph without the present filter system. This profiles is formed by logarithmized, monitor-normalized and air-calibrated data. Given utilization of a filter 7 with a constant attenuation coefficient outside the central pass region, as can be seen with reference to FIG. 5, a measured data curve of the attenuation profile S over the channels k of the detector bank 8 as seen from FIG. 5 is obtained given the same projection of the water phantom.

The two regions wherein an additional attenuation is generated due to the additional filtering can be technically localized on the basis of the attenuation values in the profile S. In FIG. 6, they lie to the left of the first pronounced change in attenuation value in channel k₁ (indicated by the upwardly directed arrow) and to the right of the second pronounced change in attenuation value in channel kᵣ (indicated by the downwardly directed arrow). In these two regions, from channel 1 to channel k₁ and from channel kᵣ to channel NDET (NDET=number of channels or detector elements), the respective attenuation values are to be reduced by a fixed amount S_{coll}:

S_{corr}(1:k₁)=S(1:k₁)−S_{coll}

S_{corr}(kᵣ:NDET)=S(kᵣ:NDET)−S_{coll},

whereby the additional attenuation value S_{coll} that is produced by the filter 7 can be determined once by previous measurement. The detection of the change in attenuation value can be implemented by simple difference formation in the following way:

DS(k)=S(k+1)=S(k), k=1:NDET−1.

k₁=k(min(DS))

kᵣ=k(max(D S))+1

Approximations are completely adequate for the correction in these calculations since the data to be corrected in the region of the channel numbers 1 through k₁ and kᵣ through NDET are not directly utilized for image reconstruction. These channel regions are only transformed corresponding to the convolution kernel length and the weight of the non-central values of the convolution kernel in the reconstruction region. Due to the differentiating properties of the convolution kernels, however, care must be exercised to ensure a steady transition from the attenuated to the unattenuated region, i.e. in the proximity of the channels k₁ and kᵣ.

For reducing the statistical uncertainty of the data in regions 2 outside the region of interest 1, the data of these regions 2 can be post-processed by a smoothing operation in the channel direction. This can ensue in the following way:

Sₜₚ(1:k₁)=low-pass {S_{corr}(1:k1)}

Sₜₚ(kᵣ:NDET)=low-pass {S_{corr}(kᵣ:NDET)}

As result, a corrected measured data curve S_{erg} of a projection composed of the unmodified data S within the region of interest and of the corrected and smoother data Sₜₚ outside is then obtained.

S_{erg}(1:k₁)=Sₜₚ(1:k₁)

S_{erg}(kᵣ:NDET)=Sₜₚ(kᵣ:NDET)

S_{erg}(k₁+1:kᵣ−1)=S(K₁+1:kᵣ−1)

Although the data in the additionally attenuated regions 2 outside the region of interest 1 are far noisier than the data in the region of interest 1, images outside the region of interest nonetheless can be reconstructed. This could be utilized, for example, when identical locations of a subject P are irradiated for a longer time in order, for example given heart exposures, to obtain motion information. At the same time, the region outside the heart could be tomographically presented for spatial orientation.

The present method and the appertaining apparatus enable a significant reduction of the dose stress of the patient, particularly when only small regions of the available measurement field actually are utilized for diagnosis. The dose reduction ensues independently of whether the region of interest lies in the rotational center or outside the rotational center of the computed tomography apparatus. As a result of the online calibration that is preferably utilized, moreover, an extremely economical realization of the required measuring system calibration can be achieved.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for registering measured data of a small region of interest in a computed tomography apparatus, comprising the steps of:
emitting an X-ray beam, having a radiation intensity distribution and which widens in a slice plane perpendicular to an examination axis;
rotating said X-ray beam around said examination axis to irradiate an examination subject, said subject having a region of interest in said slice plane, and said slice plane also encompassing regions outside of said region of interest;
detecting said X-ray beam after attenuation thereof by said examination subject to register measured data; and
during registration of said measured data, varying said intensity distribution dependent on said region of interest to cause said regions in said slice plane outside of said region of interest to be charged with a lower X-ray dose than said region of interest.

2. A method as claimed in claim 1 wherein the step of varying said intensity distribution comprises introducing a filter into said X-ray beam having a filter characteristic with a centrally disposed pass maximum, and transversely displacing said filter relative to said X-ray beam in said slice plane dependent on said region of interest.

3. A method as claimed in claim 2 comprising employing a filter having a mechanically adjustable width of said pass maximum as said filter, and constantly adapting said width of said pass maximum dependent on said region of interest.

4. A method as claimed in claim 1 comprising the additional step of normalizing said measured data to the intensity distribution of said X-ray beam.

5. A method as claimed in claim 4 comprising normalizing said measured data by comparing said measured data to a calibration table generated prior to registration of said measured data, for a geometry of said region of interest.

6. A method as claimed in claim 4 comprising normalizing said measured data by determining constant attenuation values of said filter outside of said region of interest prior to registering said measured data, logarithmizing said measured data registered outside of said region of interest to generate logarithmized measured data, and subtracting said constant attenuation values from said logarithmized measured data.

7. A method as claimed in claim 6 comprising identifying said measured data registered outside of said region of interest by a discontinuous change in a curve of said measured data that occurs upon transition to said region of interest.

8. A method as claimed in claim 1 comprising subjecting measured data registered outside of said region of interest to a noise-reducing procedure selected from the group consisting of smoothing and filtering.

9. A computed tomography apparatus comprising:
an X-ray source which emits an X-ray beam having a radiation intensity distribution, said X-ray beam widening in a slice plane perpendicular to an examination axis;
an arrangement for rotating said X-ray beam around said examination axis, adapted to irradiate an examination subject, said examination subject having a region of interest contained in said slice plane and said slice plane also containing regions outside of said region of interest;
a radiation detector disposed for detecting said X-ray beam after attenuation by said examination subject to register measured data representing X-rays incident on said radiation detector;
a filter having a centrally disposed pass maximum disposed in a path of said X-ray beam, said filter being mounted so as to be mechanically displaceable in said slice plane transversely relative to said X-ray beam;
a drive unit connected to said filter for mechanically displacing said filter; and
a controller connected to said drive unit for operating said drive unit during registration of said measured data to cause said filter to be mechanically displaced in said slice plane transversely relative to said X-ray beam dependent on said region of interest for causing said X-ray beam to charge said regions in said slice plane outside of said region of interest with a lower X-ray dose than said region of interest.

10. A computed tomography apparatus as claimed in claim 9 wherein said filter has mechanically adjustable pass width, and wherein said computed tomography apparatus comprises a further drive unit connected to said filter and operated by said controller to constantly adjust said width of said pass maximum during said registration of said measured data.

11. A computed tomography apparatus as claimed in claim 9 further comprising a processor supplied with said measured data which normalizes said measured data to said intensity distribution.

12. A computed tomography apparatus as claimed in claim 11 wherein said processor normalizes said measured data by comparing said measured data to a calibration table produced before said registration of said measured data, of a geometry of said region of interest.

13. A computed tomography apparatus as claimed in claim 11 wherein said processor normalizes said measured data by determining constant attenuation values of said filter outside of said region of interest, logarithmizing measured data registered outside of said region of interest to produce logarithmized measured data, and subtracting said constant attenuation values from said logarithmized measured data.

14. A computed tomography apparatus as claimed in claim 13 wherein said processor identifies said measured data registered outside of said region of interest by identifying a discontinuous change in a curve of said measured data which occurs upon transition to said region of interest.

15. A computed tomography apparatus as claimed in claim 9 further comprising a processor supplied with said measured data for subjecting said measured data to a noise-reducing procedure selected from the group consisting of smoothing and filtering.
